(19) United States
(12) Patent Application Publication
(10) Pub. No.: US 2012/0078748 A1
(43) Pub. Date: Mar. 29, 2012

(54) Computer Based Procurement System and Method

(76) Inventors: Sachin Sharma, Cranbury, NJ (US); Prasad Gupte, Mumbai (IN)

(21) Appl. No.: 13/315,281

(22) Filed: Dec. 8, 2011

(30) Foreign Application Priority Data
Oct. 11, 2011 (IN) 2868/MUM/2011

(51) Int. Cl. G06Q 30/06

(52) U.S. Cl. 705/26.8

(57) ABSTRACT

Computer based procurement system and method. The method comprises receiving search input for item to be purchased and searching one or more electronic catalogs to identify at least one item in the one more catalogs that relates to the search input. The method also comprises determining a uniform taxonomy code (UTC) associated with the at least one item and accessing one or more pre-configured purchasing control rules associated with the UTC. Moreover, the method comprises performing action associated with purchase order generation based at least upon the one or more pre-configured purchasing control rules.

### CROSS-REFERENCES TO RELATED APPLICATIONS

The present invention claims priority to the Indian Patent Application No. 2868/MUM/2011, titled “Computer Based Procurement System and Method”, filed Oct. 11, 2011; which is herein incorporated by reference.

### BACKGROUND OF THE INVENTION

The present invention is generally related to techniques for procurement of material and services in organizations. More specifically, the present invention provides computer based procurement system and method.

The procurement function in the organization often purchases various types of goods and services. These goods and services may be offered by different vendors. These vendors typically provide catalogs specifying their offerings. It is desirable for the procurement function to be able to peruse various catalogs before making the purchasing decision. It is also desirable for the organizations to be able to ensure that certain policies and/or best practices are adhered to when the purchasing decisions are made.

Accordingly, the present invention provides certain improved techniques to facilitate procurement of goods and services.

### SUMMARY OF THE INVENTION

It is an object of the present invention to provide computer based procurement system and method. The techniques according to the present invention advantageously facilitate importing electronic catalogs in the computer system and associating UTCs (uniform taxonomy codes) with the goods/services included in the catalogs. The invention facilitates configuration of one or more purchasing controls with any of the UTCs. These controls can be enforced at the time stored catalogs are searched and/or at the time purchase orders are created for the UTC. Moreover, the present invention also permits searching web based online catalogs. Preferably, the matching item found in the online catalog search is mapped to UTC and the purchasing controls configured for the UTC can be enforced when purchase orders are created or sought to be created.

In a specific embodiment of the present invention, a computer based system for procurement is provided. The system comprises a processor unit. Moreover, the system comprises a computer readable medium storing instructions. The instructions are executable by the processor unit to perform the steps of receiving search input for item to be purchased and searching one or more electronic catalogs to identify at least one item in the one more catalogs that relates to the search input. The instructions are also executable by the processor to perform the steps of determining a uniform taxonomy code (UTC) associated with the at least one item and accessing one or more pre-configured purchasing control rules associated with the UTC. Moreover, the instructions are executable to perform action associated with purchase order generation based at least upon the one or more pre-configured purchasing control rules. In alternative embodiment, method for computer based procurement is provided.

These and other various objects, features, advantages, and benefits of the present invention can be more fully appreciated with reference to the detailed description and accompanying drawings that follow.

### BRIEF DESCRIPTION OF THE DRAWINGS

Embodiments of the present invention are illustrated in the figures of the accompanying drawings. The figures are provided to aid thorough understanding of the invention and are exemplary rather than limiting. Based on the present teachings, person of ordinary skill in the art can contemplate various alternatives, variations and modifications to the illustrated embodiments within the scope of the invention disclosed herein.

FIG. 1 illustrates an exemplary computer network environment appropriate for a specific embodiment of the present invention.

FIG. 2 illustrates an exemplary computer apparatus that can provide a computing platform to practice specific embodiments of the present invention.

FIG. 3 illustrates an exemplary schematic of a procurement system according to a specific embodiment of the present invention.

FIG. 4 illustrates an exemplary flow of steps in a procurement method according to a specific embodiment of the present invention.

FIG. 4A illustrates an exemplary flow of steps for importing computer readable catalogs for products/services, according to a specific embodiment of the present invention.

### DETAILED DESCRIPTION OF THE INVENTION

The following detailed description of the invention refers at various places to the accompanying drawings and specific environments, applications, platforms, examples, computer screenshots, and implementations. The detailed description is provided for thorough understanding of the present invention and is illustrative rather than limiting.

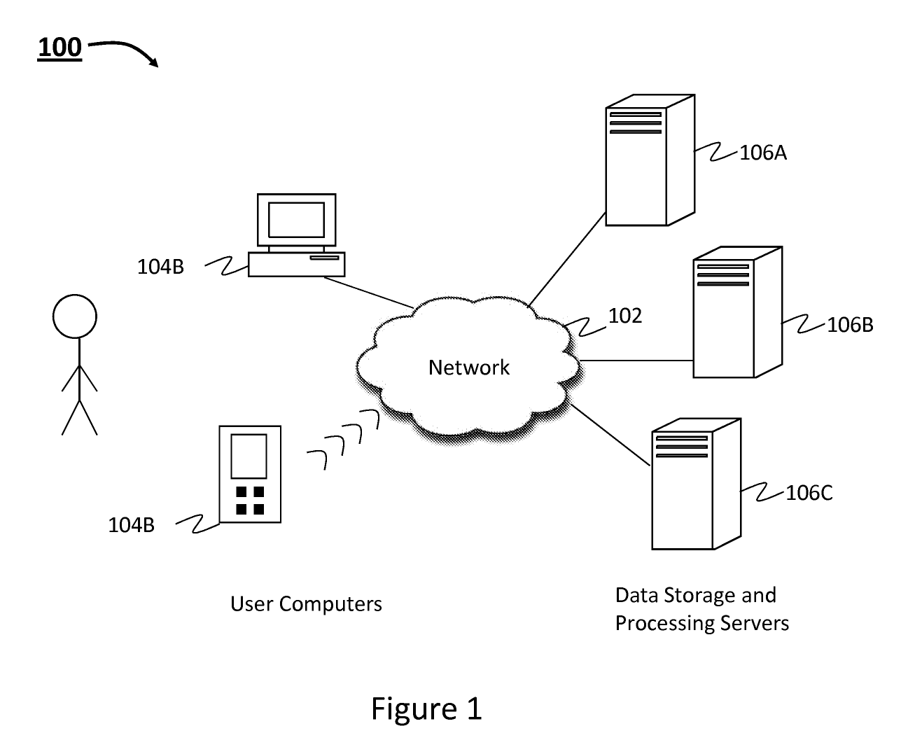

FIG. 1 illustrates an exemplary networked computer system 100 which can provide an environment to practice certain specific embodiments of the present invention. As shown in FIG. 1, multiple end user computer systems 104 and multiple server computer systems 106 can be coupled to a computer network 102. For example, the computer network 102 can be a private network of the organization. In alternative embodiment, the computer network 102 can include the local area network (LAN); and in yet an alternative embodiment it can include the Internet. The end user computer systems 104 can include without limitation desktop computers, laptop computers, personal digital assistant (PDAs), tablets, and smart phones. The computer systems 104, 106 etc. can exchange information using the computer network 102.

The servers 106 store digitized content which can be accessed (e.g., read, downloaded, searched, changed etc. as appropriate) over the computer network. A specific portion of the content is often identified using a hyperlink. The content stored in one server can also be accessed by another server and by the end user computer system. Popular techniques for accessing the content include HTTP and (HyperText Transfer Protocol) and HTTPS (HypterText Transfer Protocol Secure), though other techniques can also be used. Access to some portions of the content may require authentication and/or authorization for access.

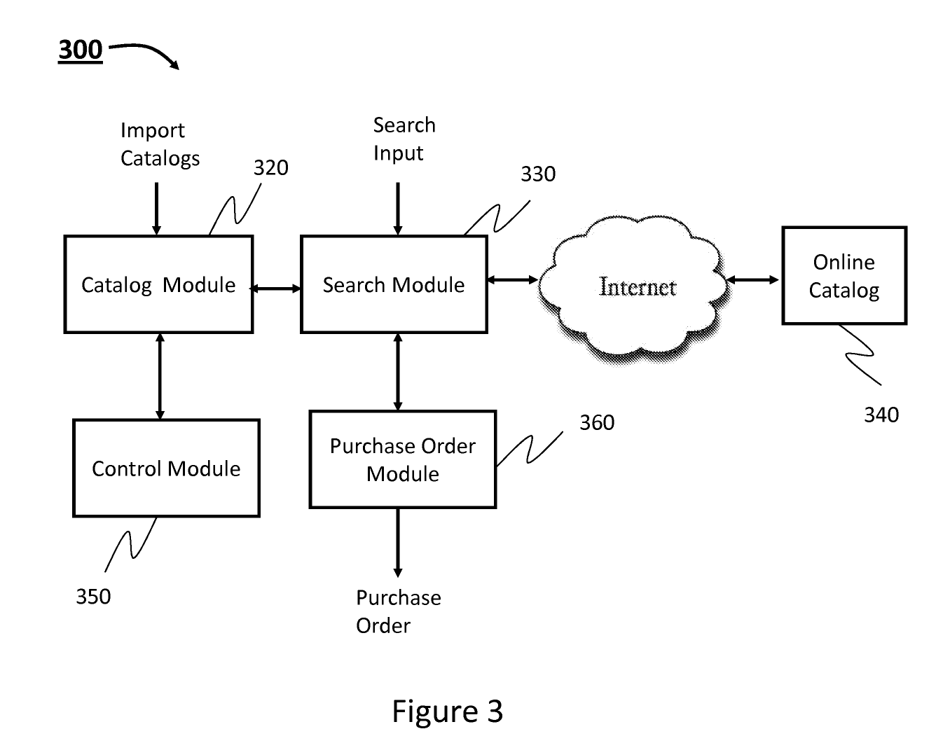

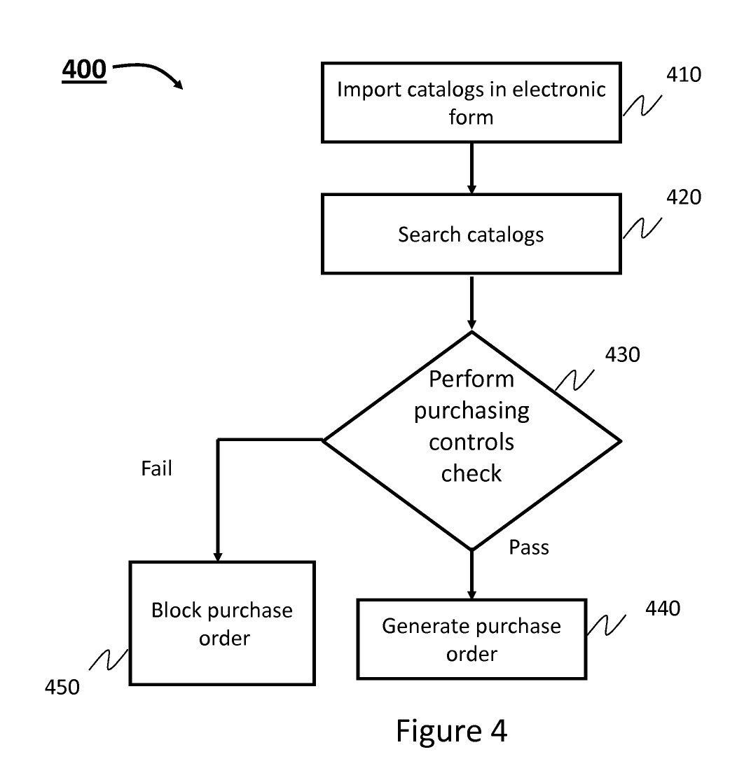

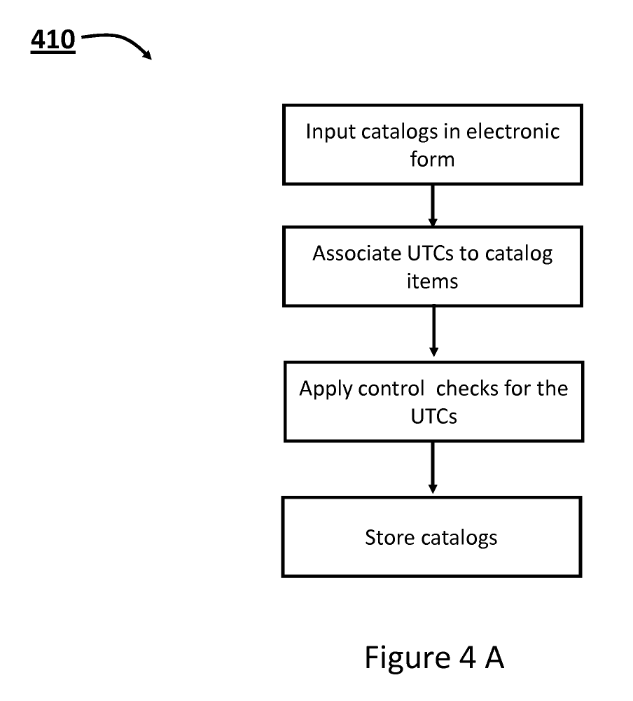

Depending upon embodiments of the present invention, the servers 106 and the computer systems 104 can be configured to perform certain acts. For example, the servers 106 and the computer systems 104 can include software which can facilitate performing these acts. These acts can include various acts performed by the various modules illustrated in FIG. 3. Moreover, these acts can include various acts performed by during the process illustrated in FIG. 4.

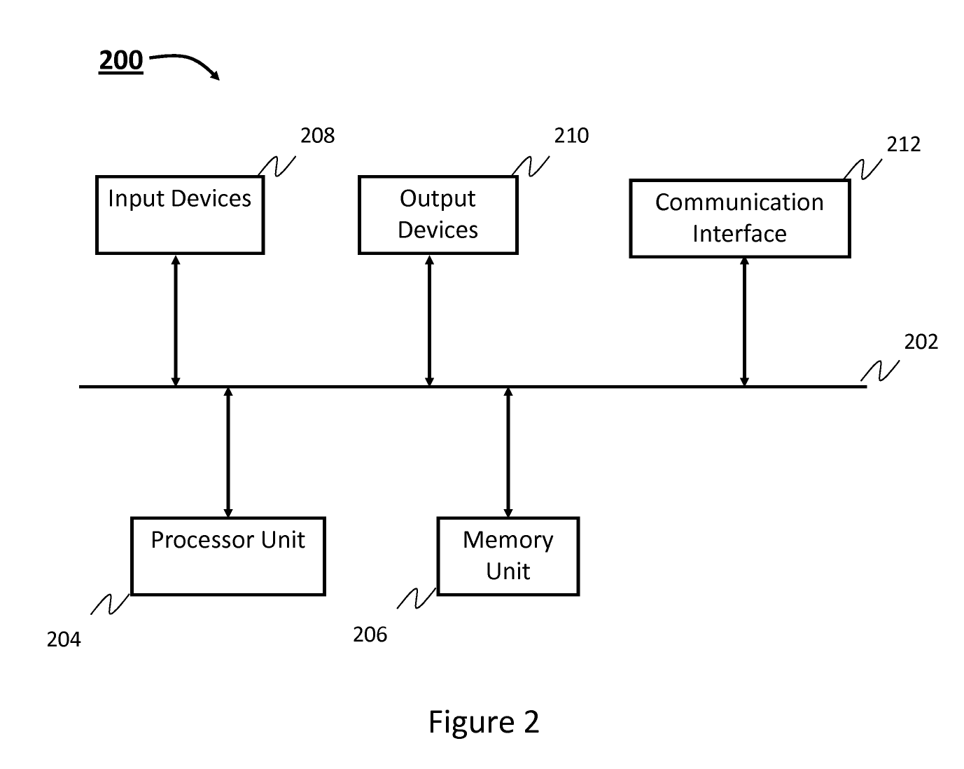

FIG. 2 illustrates an exemplary implementation of any of the servers 106 or any of the end user computer system 104, according to an embodiment of the present invention. The bus 202 permits communication among the components. The processor unit 204 may include one or more microprocessors, microcontrollers, RISC processors, CISC processors etc. The processor unit can interpret and execute instructions. The memory unit 206 may include any type of one or more volatile storage devices, for example, random access memory (RAM). The memory unit 206 may in addition or alternatively include any type of one or more persistent storage devices, for example read only memory (ROM), read write memory, hard disc, flash memory etc. The memory unit stores information and instructions for execution by the processor unit 204.

The input devices 208 may include one or more mechanisms that permit an operator to input information, such as a keyboard, mouse, pen, magnetic drives, optical drives etc. The output devices 210 may include one or more mechanisms that output information to the operator, including a display, a printer, a speaker etc. The communication interface 212 may include any transceiver mechanism that enables communication with other devices and systems via a network. For example, the communication interface can include Ethernet interface, optical network interface, wireless interface etc.

FIG. 3 illustrates an exemplary schematic 300 of a procurement system according to an embodiment of the present invention. As shown in FIG. 3, the system 300 comprises various modules. Each of these modules can be a hardware module, a software module, or combination thereof. Moreover, depending upon the embodiment, each of the modules can reside on a single computer system or can be distributed across a plurality of interconnected computers. The user interaction module (not shown) provides interface between user and machine, and performs acts such as receiving input from user and providing output to the user. The catalog module 320 can store catalogs from one or more vendors in electronic form. The search module 330 can perform searching for desired items based upon the search input provided by the user. The search module can perform searching on the information stored in the catalog module 320 and/or in online catalogs 340. The control module 350 can enforce certain purchasing controls at the time catalog data is received in the catalog module and/or at the time search is performed and/or at the time purchase order is generated. The purchase order generation module 360 can facilitate creation and submission of purchase orders.

An exemplary flowchart 400 illustrating certain steps in a computer based procurement process according to a specific embodiment of the present invention is shown in FIG. 4. As shown in FIG. 4, the process can permit inputting of goods/services catalogs in a computer system (step 410). Preferably, the catalogs to be inputted are in computer readable form. Moreover, according to certain embodiments of the present invention, the catalogs so inputted are stored in the computer system along with the UTCs (uniform taxonomy codes) for goods/services in the catalog. More specifically, the process according the present invention facilitates using pre-configured rules to match specific goods/services in the catalogs to the UTCs.

Taxonomy refers to classification, which can include multiple taxonomy codes in a flat or hierarchical structure. For example, flat taxonomy can include classification such as manufacturing and construction, transportation and logistics, services, information technology and telecommunication, agriculture, chemicals, etc. As another example, hierarchical taxonomy can include hierarchical classification. For example, the category information technology (code: 43000000) can include subcategory for communication devices (code: 43190000), which can include further subcategory for personal communication devices (code: 43191500), which can include mobile phone (code: 43191501), pager (code: 43191502), etc.

According the present invention UTCs can be used from standard taxonomies such as, for example, UNSPSC (United Nations Standard Products and Services Code), NAICS (North American Industry Classification System), etc. Alternatively industry specific UTCs can be used. Yet alternatively, proprietary UTCs can also be used.

Moreover, in specific embodiments, the process also facilitates enforcing certain pre-configured controls on the catalogs that are inputted (as illustrated in FIG. 4A by exemplary flow of steps (410) for importing the catalogs). For example, UTC of the product/service is used to identify the controls to be enforced on specific catalog or specific product/service in the catalog. More specifically, certain controls can be pre-configured in the system for a specific UTC. Examples of the controls include allowing/disallowing inputting of certain goods/services based upon vendor identity, list price criteria, quality criteria, favoring one vendor over another, etc. For example, an electronic catalog received from Dell Computers can be permitted to be used for the taxonomy codes of Notebook Computers (43211503) and Desktop computers (43211507), but not permitted for the taxonomy code for ‘Computer Servers’ (43211501).

In a specific embodiment, the process permits marking certain items in the catalogs as approved/unapproved based on one of the above and/or other criteria. In an alternative specific embodiment, the process permits blocking the importing of the items that are not approved. In further alternative specific embodiments, the process permits associating certain attributes with items in the imported catalogs. Examples of the attributes include “favored vendor”, “incumbent vendor”, “contracted vendor”, etc. Additional examples include, “price above threshold”, “quality below threshold”, “shipping cost above/below threshold”, etc.

At step 420, the process permits free form search queries on the catalogs that are inputted. For example, the keywords from the query are matched with goods/services descriptions in the catalogs to fetch matching items.

Based on the UTCs for the matching items, the process permits checks to enforce controls (step 430) configured with the UTCs. More specifically, certain controls can be pre-configured in the system for a specific UTC. Examples of the controls include favoring one vendor over another, ensuring compliance with the contract negotiated with vendor, etc.

If the controls check passes, the process permits automatic retrieval of the computer based purchase order template. The user can then fill the purchase order template and submit it for requisition (step 440). On the other hand, if the controls check does not pass on certain item, the purchase order generation for that item is blocked (step 450).

In specific embodiment, in addition to or instead of searching catalog data, the process also permits searching web based online catalogs at step 420. The matching item found during the online catalog search is mapped to UTC and the controls check configured with the UTC is performed on the item. If the controls check does not pass, the user is not permitted to issue purchase order on that item. On the other hand if the control check passes, the process permits (as in step 440) automatic retrieval of the computer based purchase order template. The user can then fill the purchase order template and submit it for requisition. As merely an example to illustrate this embodiment, consider that the control is configured to use electronic catalog hosted by the vendor “Staples” for use with taxonomy code for ‘Office Equipment and Accessories and Supplies’ (Code: 44000000) and its child categories (i.e., all other taxonomy codes that begin with 44). Suppose the user searches for and returns from the “Staples” online catalog with a ‘Dell XPS 14’ laptop in shopping cart. Then, this embodiment will block the purchase, since the use of the “Staples” online catalog is not allowed for the taxonomy code 43211503 corresponding to Notebook computers.

In certain embodiments, certain controls can be applied after the item is submitted for requisition (e.g., as in step 440). Alternatively or in addition, certain controls can be applied before step 440 before raising purchase order. Certain illustrative examples of such controls are described below:

Category experts: Category experts can be associated to certain UTCs. In this example, approval of such expert is required before item can be purchased. For example, Bob could have knowledge of hydraulic pumps. So, when hydraulic pumps are to be purchased, depending on configuration, the workflow can automatically include Bob for approval, since he is a category expert who is associated to the taxonomy code ‘40151533’ for ‘Hydraulic Pumps’. Alternatively, UTCs can also be mapped to user groups in the system, or specific roles or designations for approval.

Internal buyers: As another example, Alice could be knowledgeable about items belonging to the parent UTC 43000000 for ‘Information technology and telecommunication’. Thus, purchase requests/requisitions that contain items belonging to 43000000 and its child UTCs (e.g., notebook computers—43211503, keyboards—43211706, etc.), can be automatically routed for purchase to Alice. Alternatively, UTCs can also be mapped to user groups in the system, or specific roles or designations for approval for purchasing.

Supplier: A supplier can be tagged to the uniform taxonomy code to indicate the products and services provided by the said supplier. Also, one or more suppliers can be marked as a preferred supplier for a taxonomy code. When an order is being placed, system can check to see if the supplier supplies items belonging to a taxonomy code, and whether the supplier is preferred for that code. For example, consider 3 suppliers tagged to the uniform taxonomy code as follows: Dell Computers for notebook computers (43211503, preferred), desktop computers (43211507, preferred); Lafarge for cement (30111601, not preferred); and Cemex for cement (30111601, preferred). When an order is being placed for an item that belongs to the taxonomy code 30111601 of “Cement”, the system can alert the user that although Lafarge is tagged to ‘Cement’, it is not preferred, and a preferred supplier (Cemex) already exists. If Dell is selected, system can alert the user that Dell does not provide cement, and can block the purchase based on configuration

Contract: A contract with the supplier can also be associated with the universal taxonomy codes. Moreover, specific discounts for each taxonomy code can be specified. When a contract number is being mentioned on a purchase order, system can check to see if items being purchased are allowed as per the contract. System can also determine savings from the contract for each specific taxonomy code. For example, suppose that contract #123 with Dell exists for notebook computers 43211503 (5% discount) and desktop computers 43211507 (7% discount). If a purchase order is created for Dell Computers for ‘servers’, and contract #123 is mentioned, system will inform the user that purchase of Servers is not covered under this contract. On the other hand, if the laptop Dell Inspiron 445 is being purchased, system can compute the savings based on the discount percentage configured with the taxonomy code (5%).

Budgets: Budgets can also be associated to the universal taxonomy code. When a purchase cost is being booked to a budget, system can check if the item is allowed to be purchased on that budget. For example, the F&A budget within an organization can be used for items (products/services) such as accounting services (84111500), tax advisory services (84111802), audit services (84111600). When purchase costs for ‘Prepared and preserved foods’ (50190000) are booked to the F&A budget, system can alert the user that such purchase is not allowed on that said budget.

Accordingly, the present invention provides computer based procurement system and method. While specific embodiments are described herein, alternative embodiments will be apparent to person of ordinary skill in the art, in which one or more acts described herein can be modified, performed in different order, or omitted; without departing from the spirit of the invention. Moreover, one or more acts can be added to those described herein. Such alternatives and modifications are included within the scope of the present invention.

What is claimed is:

1. A computer based procurement system, the system comprising:
a processor unit; and
a computer readable medium storing instructions executable by the processor unit to perform the steps of:
receiving search input for item to be purchased;
searching one or more electronic catalogs to identify at least one item in the one more catalogs that relates to the search input;
determining a uniform taxonomy code (UTC) associated with the at least one item;
accessing one or more pre-configured purchasing control rules associated with the UTC; and
performing action associated with purchase order generation based at least upon the one or more pre-configured purchasing control rules.

2. The system of claim 1 wherein the search input being in free form text.

3. The system of claim 1 wherein the searching the one or more electronic catalogs including matching at least one text term in the search input with textual description of items in the one or more electronic catalogs.

4. The system of claim 1 wherein the searching the one or more electronic catalogs including:
determining UTC for item being represented by the search input; and
matching the UTC for the item being represented by the search input with UTCs of items in the one or more electronic catalogs.

5. The system of claim 1 wherein the action including blocking the generation of purchase order.

6. The system of claim 1 wherein the action including retrieval of a purchase order template associated with the UTC from one or more purchase order templates stored in the computer readable medium.

7. The system of claim 1 wherein the one or more electronic catalogs including at least one web based online catalog.

8. The system of claim 1 wherein the one or more electronic catalogs including at least one catalog stored in the computer readable medium, wherein a UTC is associated with at least one item in the at least one catalog.

9. The system of claim 8 wherein the computer readable medium stores further instructions executable by the processor unit to perform the steps of:
receiving the at least one catalog to be stored in the computer readable medium;
identifying UTC for at least one item in the at least one catalog to be stored;
accessing one or more pre-configured catalog import control rules associated with the UTC for the at least one item in the at least one catalog; and
applying the one or more pre-configured catalog import control rules while storing the at least one catalog in the computer readable medium.

10. The system of claim 1 wherein the one or more pre-configured purchasing controls rules include at least one control selected from the group consisting of approved/unapproved vendor, preferred vendor, contract compliance, expert approval, designated purchase department, and budget compliance.

11. A computer based procurement method comprising:
receiving search input for item to be purchased;
searching one or more electronic catalogs to identify at least one item in the one more catalogs that relates to the search input;
determining a uniform taxonomy code (UTC) associated with the at least one item;
accessing one or more pre-configured purchasing control rules associated with the UTC; and
performing action associated with purchase order generation based at least upon the one or more pre-configured purchasing control rules.

12. The method of claim 11 wherein the search input being in free form text.

13. The method of claim 11 wherein the searching the one or more electronic catalogs including matching at least one text term in the search input with textual description of items in the one or more electronic catalogs.

14. The method of claim 11 wherein the searching the one or more electronic catalogs including:
determining UTC for item being represented by the search input; and
matching the UTC for the item being represented by the search input with UTCs of items in the one or more electronic catalogs.

15. The method of claim 11 wherein the action including blocking the generation of purchase order.

16. The method of claim 11 wherein the action including retrieval of a purchase order template associated with the UTC from one or more purchase order templates stored in the computer readable medium.

17. The method of claim 11 wherein the one or more electronic catalogs including at least one web based online catalog.

18. The method of claim 11 wherein the one or more electronic catalogs including at least one catalog stored in the computer readable medium, wherein a UTC is associated with at least one item in the at least one catalog.

19. The method of claim 18 further comprising:
receiving the at least one catalog to be stored in the computer readable medium;
identifying UTC for at least one item in the at least one catalog;
accessing one or more pre-configured catalog import control rules associated with the UTC for the at least one item in the at least one catalog; and
applying the one or more pre-configured catalog import control rules while storing the at least one catalog in the computer readable medium.

20. The method of claim 11 wherein the one or more pre-configured purchasing controls rules include at least one control selected from the group consisting of approved/unapproved vendor, preferred vendor, contract compliance, expert approval, designated purchase department, and budget compliance.
